(19) United States
(12) Patent Application Publication
(10) Pub. No.: US 2014/0317663 A1
(43) Pub. Date: Oct. 23, 2014

(54) METHOD AND APPARATUS FOR PROVIDING BROADCASTING SERVICE

(71) Applicant: Samsung Electronics Co., Ltd., Suwon-si (KR)

(72) Inventors: Ji-Eun KEUM, Suwon-si (KR); Young-Sun RYU, Seongnam-si (KR)

(73) Assignee: Samsung Electronics Co., Ltd., Suwon-si (KR)

(21) Appl. No.: 14/256,428

(22) Filed: Apr. 18, 2014

(30) Foreign Application Priority Data
Apr. 19, 2013 (KR) 10-2013-0043785

(51) Int. Cl. H04N 21/482; H04N 21/61; H04N 21/462; H04N 21/2381; H04N 21/2665

(52) U.S. Cl. CPC H04N 21/4821; H04N 21/2381; H04N 21/2665; H04N 21/4622; H04N 21/6125
USPC 725/50; 725/110

(57) ABSTRACT

A method and apparatus for providing a broadcasting service are provided. The method includes receiving, by a first terminal, channel information of a program selected by a user from a second terminal, detecting a frequency of the selected program from a mapping table that maps the channel information to a corresponding frequency, locking a tuner of the first terminal to the detected frequency, and receiving a broadcasting service of the program from a broadcasting network server.

### CROSS-REFERENCE TO RELATED APPLICATION(S)

This application claims the benefit under 35 U.S.C. §119(a) of a Korean patent application filed on Apr. 19, 2013 in the Korean Intellectual Property Office and assigned Serial number 10-2013-0043785, the entire disclosure of which is hereby incorporated by reference.

### TECHNICAL FIELD

The present disclosure relates to providing a broadcasting service in a communication system. More particularly, the present disclosure relates to a method and apparatus in which a TeleVision (TV) receives channel information through a portable terminal and provides a broadcasting service.

### BACKGROUND

As TeleVisions (TVs) have recently evolved into forms for providing various functions such a Hybrid Broadcast Broadband TV (HbbTV) supporting a broadcast channel, a wideband broadcast channel, and an Internet Protocol (IP) channel to provide various broadcasting service applications.

Mobile phone terminals have evolved into smart phones that provide various useful functions to users through applications and have become common in use. Moreover, recent users use electronic devices such as a tablet Personal Computer (PC), a laptop PC, and the like with the mobile phone terminal such as a smart phone, and also use a TV together at home.

Since the users use contents using various electronic devices, services allowing use of the electronic devices have also been proposed variously and each technique has been combined with another technique. Thus, content or services are transmitted using one path or a plurality of paths on a heterogeneous network and a user may consume a converged service in a broadcasting-and-communication convergence environment.

As communication technology has been developed and performance of a receiver has been enhanced, devices with large and high-resolution displays, which are capable of accessing a plurality of heterogeneous networks through convergence of broadcasting and communication, have been released to the market. Therefore, a need exists for a new transmission service for flexibly providing a convergence service of broadcasting and communication to users in such an environment.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above- mentioned problems and/or disadvantages and to provide at least the advantages described below. Accordingly, an aspect of the present disclosure is to provide a method and apparatus for providing a broadcasting service in a communication system.

Another aspect of the present disclosure is to provide a method and apparatus in which a TeleVision (TV) receives channel information through a portable terminal and receives a broadcasting service from a broadcast network server or an Internet network server in a communication system.

In accordance with an aspect of the present disclosure, a method for providing a broadcasting service at a first terminal is provided. The method includes receiving channel information of a program selected by a user from a second terminal, detecting a frequency of the selected program from a mapping table that maps the channel information to a corresponding frequency, locking a tuner to the detected frequency, and receiving a broadcasting service of the program from a broadcasting network server.

In accordance with another aspect of the present disclosure, a method for providing a broadcasting service at a first terminal is provided. The method includes receiving information related to a broadcasting service from an Internet network server, generating an Electronic Program Guide (EPG) using the received information, and transmitting channel information of a program selected by a user based on the EPG to a second terminal to provide the broadcasting service if the channel information is input.

In accordance with another aspect of the present disclosure, a terminal for providing a broadcasting service is provided. The terminal includes a broadband interface configured to receive channel information of a program selected by a user, a broadcast managing module configured to detect a frequency of the selected program from a mapping table that maps the channel information to a corresponding frequency and lock a tuner of the terminal to the detected frequency, and a broadcast interface module configured to receive a broadcasting service of the program from a broadcasting network server.

In accordance with another aspect of the present disclosure, a terminal for providing a broadcasting service is provided. The terminal includes a receiver configured to receive information related to the broadcasting service from an Internet network server, a controller configured to generate an EPG using the received information, and a transmitter configured to transmit channel information of a program selected by a user based on the EPG to provide the broadcasting service if the channel information is input.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating a configuration of a Hybrid Broadcast Broadband Television (HbbTV) network according to an embodiment of the present disclosure;

FIG. 2 is a diagram illustrating a configuration of a HbbTV network according to a first embodiment of the present disclosure;

FIG. 3 is a diagram illustrating a procedure for receiving broadcast contents in an HbbTV network according to a first embodiment of the present disclosure;

FIG. 4 is a diagram illustrating a configuration of an HbbTV network according to a second embodiment of the present disclosure;

FIG. 5 is a diagram illustrating a procedure for receiving broadcast contents in an HbbTV network according to a second embodiment of the present disclosure;

FIG. 6 is a block diagram of a TeleVision (TV) terminal according to an embodiment of the present disclosure; and

FIG. 7 is a block diagram of a portable terminal according to an embodiment of the present disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

In the following detailed description, representative various embodiments will be provided in the present disclosure for achieving the above-described technical problems. For convenience, names of entities defined in the Hybrid Broadcast Broadband Television (HbbTV) standard will be used, but particular standards or names of entities thereof do not limit the scope of the present disclosure, and the description of the present disclosure is also applicable to any system having a similar technical background.

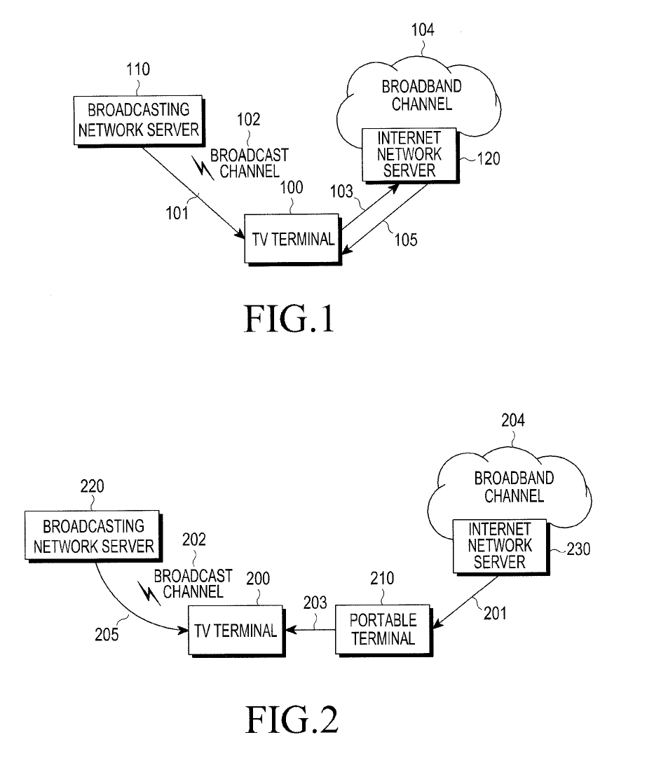

FIG. 1 is a diagram illustrating a configuration of an HbbTV network according to an embodiment of the present disclosure.

Referring to FIG. 1, a TeleVision (TV) terminal (or a contents playback terminal) 100 receives a broadcasting service, for example, broadcast contents including Audio and Video (AN) content from a broadcasting network server 110 through a broadcast channel 102 in operation 101. The broadcast channel 102 refers to a transmission channel provided over a broadcasting network.

The TV terminal 100 receives information related to the broadcast contents or the broadcast service from an Internet network server 120 through a broadband channel 104 in operation 105. The broadband channel 104 is a high speed wired/wireless Internet communication channel, and may be, for example, an interactive channel provided over an interactive network such as a cellular system. The broadcasting network server 110 transmits metadata of an application related to broadcast contents to the TV terminal 100 through an Application Information Table (AIT) in operation 101. The metadata may include various types of information such as a webpage and an application program related to the broadcast content and Internet connection information (for example, an address of an Internet network server) for receiving information related to the broadcast contents or the broadcast service, which can be executed with an application in the TV 100.

The TV terminal 100 sends a request for information related to the broadcast service to the Internet network server 120 by using the metadata received from the broadcasting network server 110 in operation 103 and receives the information related to the broadcast service from the Internet network server 120 as a response in operation 105.

Contents of the application may be provided to the TV terminal 100 through at least one of the Internet network server 120 and the broadcasting network server 110. The contents of the application may also be provided to the TV terminal 100 through at least one of the broadcast channel 102 and the broadband channel 104. When the application is provided through the Internet network server 120, the broadcasting network server 110 (an application provider) provides the application to the TV terminal 100 by using the Internet network server 120 or a separate communication means (for example, a backbone network).

Referring to FIG. 1, as an example, the TV terminal 100 sends a request for information related to a broadcast service to the Internet network server 120 and receives the information related to the broadcast service in response. However, the information related to the broadcast service may be received by the TV terminal 100 through a separate portable terminal. An example in which the information related to the broadcast service is received by the TV terminal 100 through the separate portable terminal will be described in more detail with reference to FIG. 2.

FIG. 2 is a diagram illustrating a configuration of an HbbTV network according to a first embodiment of the present disclosure.

Referring to FIG. 2, a portable terminal 210 receives information related to a broadcast service from an Internet network server 230 through a broadband channel 204 in operation 201. Herein, the portable terminal 210 may be, for example, a smart phone, a tablet Personal Computer (PC), or the like.

The information related to the broadcast service may include any information of broadcast contents that can be provided to users. More specifically, the information of broadcast contents may be configured and transmitted in the form of an Event Information Table (EIT), a Service Description Table (SDT), and a Network Information Table (NIT) with respect to metadata of the Digital Video Broadcasting (DVB) standard.

The EIT may include program related information such as an event IDentifier (ID) indicating a name of a program, a start time of the program, and a duration of the program. The EIT is transmitted every two seconds.

For example, the EIT may be configured to include information such as an event ID of ‘8 News’, a program start time of ‘20:00’, and a program duration of ‘1 hour’.

The SDT may include service (or channel)-related information such as a service ID indicating a channel name or a service provider name. For example, the service related information may be broadcasting network server information such as Korean Broadcasting System (KBS), Seoul Broadcasting System (SBS), Media Broadcast Corporation (MBC), Educational Broadcasting System (EBS), or the like.

The NIT may include any network information sent from a current network. That is, the NIT is information regarding a physical configuration of a multiplexer/Transport Stream (TS) in a particular DVB network, and may include at least one of a physical parameter of a TS, a cell list, a DVB network name, a frequency band, and an indication to apply time slicing and Forward Error Correction (FEC). The NIT may be transmitted every 10 seconds.

The portable terminal 210 generates an Electronic Program Guide (EPG) by using the information related to the broadcast service received in operation 201. Herein, the EPG refers to a broadcast program guide service that outputs at least one of a TV program broadcasting time, the entire or some contents of a program, and information about cast members of the program by using an empty frequency band or an additional channel of a TV broadcast.

Thereafter, a user selects a program to be watched based on the generated EPG and transmits the channel information of the selected program to a TV terminal 200 in operation 203. The TV terminal 200 is merely an example and any terminal that displays an image may be connected with the portable terminal 210 to receive the channel information of the selected program.

Herein, as an example, the portable terminal 210 generates the EPG by using the information related to the broadcast service, but the EPG may be generated by the Internet network server 230 and provided to the portable terminal 210. In this case, the Internet network server 230 may generate the EPG and transmit the EPG to the portable terminal 210 through separate signaling and the user may select a desired program based on the received EPG and transmit channel information of the selected program to the TV terminal 200.

The channel information of the selected program may include at least one of an event ID and a service ID of the selected program.

The TV terminal 200, having received the channel information (that is, at least one of the event ID and the service ID) of the selected program, detects a corresponding channel based on the received information by using a mapping table managed by the TV terminal 200. The TV terminal 200 locks a tuner to a corresponding frequency of the detected channel and receives broadcast content of the channel from the broadcasting network server 220 through the broadcast channel 202 in operation 205. The mapping table indicates a mapping relationship between at least one of the event ID and the service ID of the program and a corresponding frequency. The mapping table may be generated in advance by the TV terminal 200 based on information periodically received from the broadcasting network server 220 or may be received directly from the Internet network server 230.

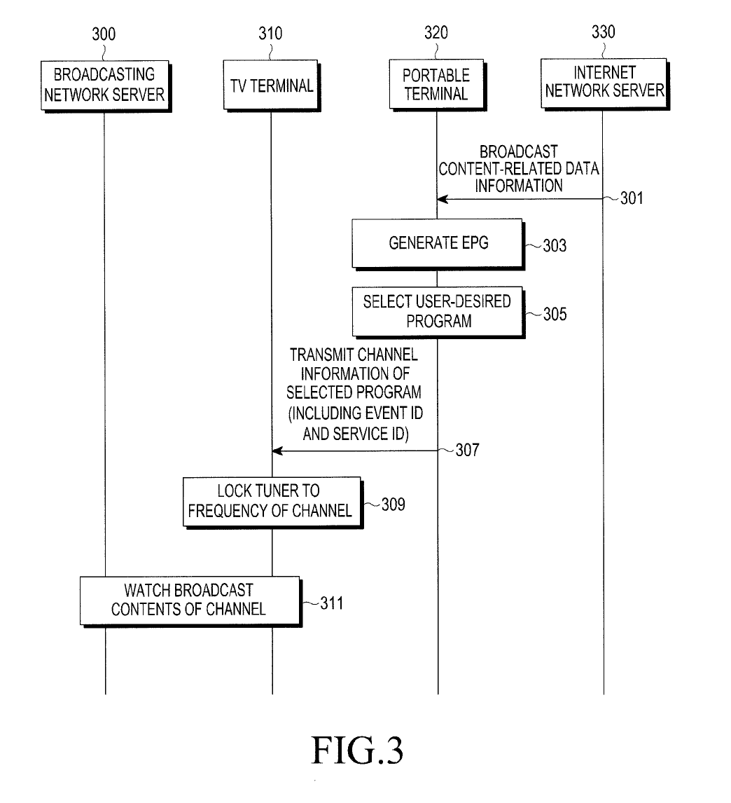

FIG. 3 is a diagram illustrating a procedure for receiving broadcast contents in the HbbTV network according to the first embodiment of the present disclosure.

Referring to FIG. 3, the HbbTV network may include a broadcasting network server 300, a TV terminal 310, a portable terminal 320, and an Internet network server 330.

The portable terminal 320 receives information related to a broadcast service from the Internet network server 330 in operation 301. The information related to the broadcast service may include any information of broadcast contents that can be provided to a user, and more specifically, the information of broadcast contents may be configured and transmitted to the portable terminal 320 in the form of an EIT, SDT, NIT, or the like with respect to DVB metadata.

The portable terminal 320 generates an EPG by using the received information related to the broadcast service in operation 303. Herein, as an example, the portable terminal 320 generates the EPG by using the information related to the broadcast service, but the EPG may be generated by the Internet network server 330 and provided to the portable terminal 320 through separate signaling. The EPG refers to a broadcast program guide service that outputs at least one of a TV program broadcasting time, the entire or some contents of a program, and information about cast members of the program by using an empty frequency band or an additional channel of a TV broadcast.

Thereafter, in operation 305, the user selects a program to be watched (i.e., a desired program) based on the EPG and the portable terminal transmits channel information of the selected program to the TV terminal 310 in operation 307. The channel information of the selected program may include, for example, at least one of an event ID and a service ID of the selected program.

The TV terminal 310, having received the channel information (that is, at least one of the event ID and the service ID) of the selected program, detects a corresponding channel based on the received information by using a mapping table managed by the TV terminal 310. The TV terminal 310 locks a tuner to a corresponding frequency of the detected channel in operation 309 and receives broadcast content of the channel from the broadcasting network server 300. That is, the user watches the broadcast contents received from the broadcasting network server 300 through the TV terminal 310 in operation 311. The mapping table indicates a mapping relationship between at least one of an event ID and a service ID of a program and a corresponding frequency. The mapping table may be generated in advance by the TV terminal 310 based on information periodically received from the broadcasting network server 300 or may be received directly from the Internet network server 330.

Referring to FIGS. 2 and 3, a TV terminal detects a channel based on channel information received from a portable terminal (e.g., at least one of an event ID and a service ID), locks a tuner to a corresponding frequency of the detected channel, and receives broadcast contents of the channel.

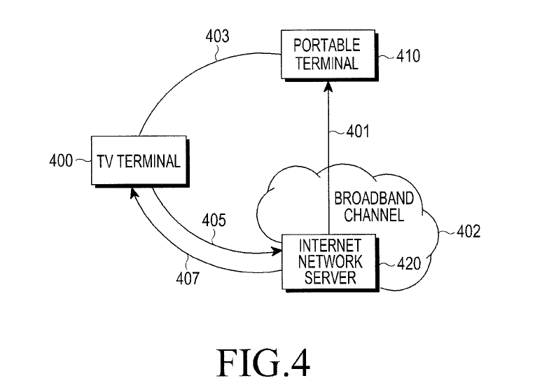

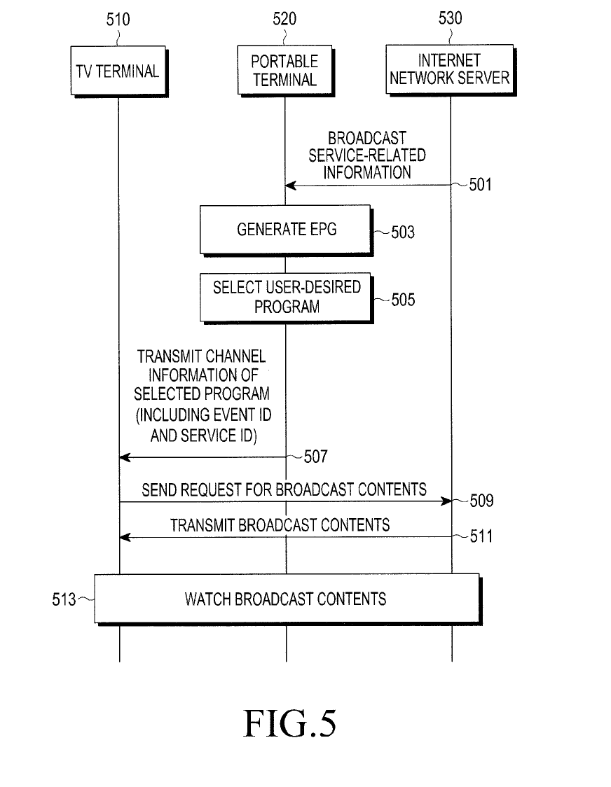

However, if connection between the TV terminal and the broadcasting network server is not stable or if a program a user desires to watch has already been broadcast, then broadcast content of the program may be received from an Internet network server. An example in which the broadcast content is received from the Internet network server will be described in more detail with reference to FIGS. 4 and 5.

FIG. 4 is a diagram illustrating a configuration of an HbbTV network according to a second embodiment of the present disclosure.

Referring to FIG. 4, a description will be made assuming that connection between a TV terminal 400 and a broadcasting network server (not illustrated) is unstable or a program that a user desires to watch has already been broadcast.

A portable terminal 410 receives information related to a broadcast service from an Internet network server 420 through a broadband channel 402 in operation 401. The information related to the broadcast service may include any information of broadcast contents that can be provided to a user, and more specifically, the information of broadcast contents may be configured and transmitted in the form of an EIT, an SDT, an NIT, and the like with respect to DVB metadata.

The EIT may include program related information such as an event ID indicating a name of a program, a start time of the program, and a duration of the program. The EIT is transmitted every two seconds.

The SDT may include service (or channel)-related information such as a service ID indicating a channel name or a service provider name. For example, the service related information may be broadcasting network server information such as National Broadcasting Company (NBC), Columbia Broadcasting System (CBS), American Broadcasting Company (ABC), or the like.

The NIT may include any network information sent from a current network. That is, the NIT is information regarding a physical configuration of a multiplexer/TS in a DVB network that includes at least one of a physical parameter of a TS, a cell list, a DVB network name, a frequency use band, and an indication to apply time slicing and Forward Error Correction (FEC). The NIT may be transmitted every 10 seconds.

The portable terminal 410 generates an EPG by using the information related to the broadcast service received in operation 401. The EPG refers to a broadcast program guide service that outputs at least one of a TV program broadcasting time, the entire or some contents of a program, and information about cast members of the program by using an empty frequency band or an additional channel of a TV broadcast.

Thereafter, the user selects a program to be watched based on the EPG and transmits channel information of the selected program to the TV terminal 400 in operation 403. Although the portable terminal 410 generates the EPG by using the information related to the broadcast service as an example, the EPG may be generated by the Internet network server 420 and provided to the portable terminal 410. In this case, the Internet network server 420 generates the EPG and transmits the EPG to the portable terminal 410 through separate signaling and the user selects a desired program from the EPG in the portable terminal 410, which transmits channel information of the selected program to the TV terminal 400.

The channel information of the selected program may include, for example, at least one of an event ID and a service ID of the selected program.

The TV terminal 400, having received at least one of the channel information (e.g., at least one of the event ID and the service ID of the selected program), detects a corresponding program based on the received information and sends a request for broadcast content of the detected program to the Internet network server 420 through the broadband channel 402 in operation 405. The Internet network server 420 transmits the broadcast contents to the TV terminal 400 in response to the request in operation 407.

FIG. 5 is a diagram illustrating a procedure for receiving broadcast contents in an HbbTV network according to the second embodiment of the present disclosure.

Referring to FIG. 5, a description will be made assuming that a connection between a TV terminal 510 and a broadcasting server is unstable or a program that a user desires to watch has already been broadcast. The HbbTV network may include an Internet network server 530, a portable terminal 520, and the TV terminal 510.

The Internet network server 530 transmits information related to a broadcast service to the portable terminal 520 in operation 501. The information related to the broadcast service includes any information of broadcast contents that can be provided to the user, and more specifically, the information of broadcast contents may be configured and transmitted to the portable terminal 520 in the form of an EIT, an SDT, an NIT, or the like with respect to DVB metadata.

The portable terminal 520 generates an EPG by using the information related to the broadcast service in operation 503. Although, as an example, the portable terminal 520 generates an EPG using the information related to the broadcast service, the EPG may also be generated by the Internet network server 530 and provided to the portable terminal 520 through separate signaling. The EPG refers to a broadcast program guide service that outputs at least one of a TV program broadcasting time, the entire or some contents of a program, and information about cast members of the program by using an empty frequency band or an additional channel of a TV broadcast.

Thereafter, a user selects a program to be watched (i.e., a desired program) based on the EPG in operation 505 and the portable terminal 520 transmits channel information of the selected program to the TV terminal 510 in operation 507. The channel information of the selected program may include, for example, at least one of an event ID and a service ID of the selected program.

The TV terminal 510, having received the channel information (i.e., at least one of the event ID and the service ID) of the selected program, detects the program based on the received information and sends a request for broadcast content of the detected program to the Internet network server 530 in operation 509. The Internet network server 530 transmits the broadcast content to the TV terminal 510 in response to the request in operation 511. Thus, the user may watch the broadcast contents received from the Internet network server 511 through the TV terminal 520 in operation 513.

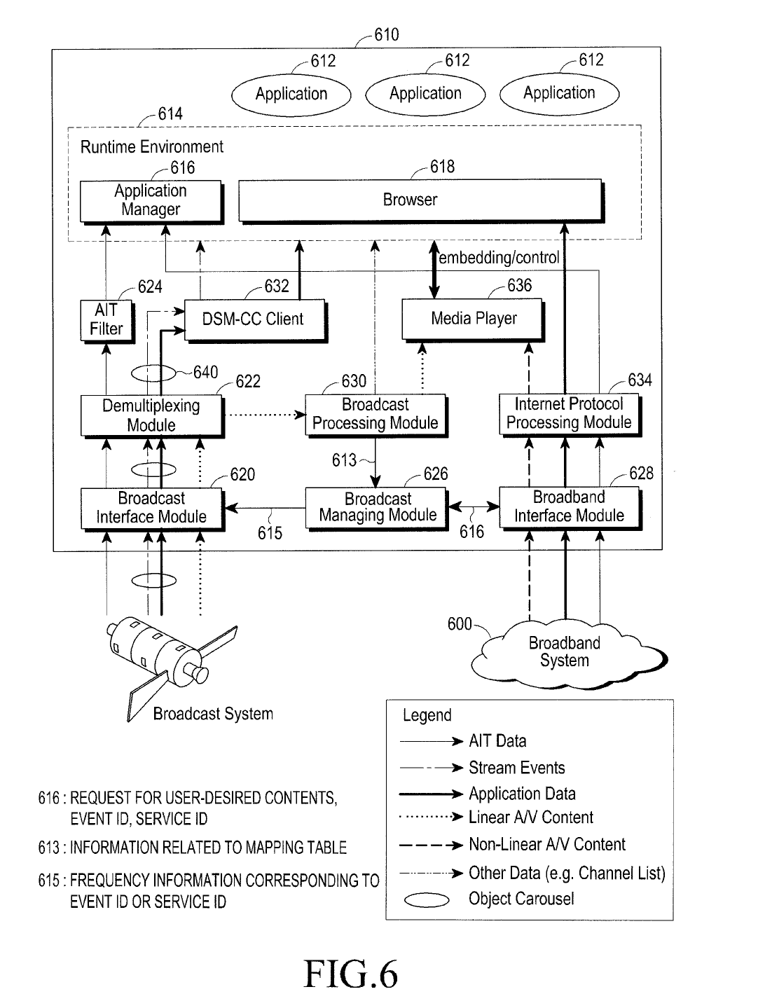

FIG. 6 is a block diagram of a TV terminal according to an embodiment of the present disclosure.

Although a broadcast managing block 626 is added to an existing broadcasting-and-communication convergence terminal, that is, a TV terminal in FIG. 6, the present disclosure is also applicable to any type of terminal capable of accessing a broadcast channel and a broadband channel.

Referring to FIG. 6, a TV terminal 610 receives AIT data, linear A/V content, an application, and a stream event from a broadcasting server through a broadcast interface 620. The received information is delivered to an AIT filter 624, a Digital Storage Media Command and Control (DSM-CC) client 632, and a broadcast processing module 630 via a demultiplexing module 622. The DSM-CC client 632 reconstructs the last two data streams delivered through a DSM-CC object carousel 640 and provides the reconstructed data streams to a runtime environment processing module 614.

The runtime environment processing module 614 refers to a component in which interactive applications 612 are executed. A browser 618 and an application manager 616 form the runtime environment processing 614. The application manager 616 evaluates AIT data provided via the AIT filter 624 and controls a corresponding interactive application. The browser 618 executes the interactive application and responds to an operation of the application.

The linear A/V content may be processed by the broadcast processing module 630 similar to the standard DVB TV terminal The broadcast processing module 630 includes any DVB function provided in the standard DVB TV terminal 610. The broadcast processing module 630 provides additional information and functions such as a channel list, an EIT present/following (p/f) table, and a tuning function to the runtime environment processing 614. If any of the applications 612 scales and embeds linear A/V content through a user interface, a media player 636 provides functions for processing of the A/V content.

A broadband interface module 628 provides a connection with a broadband system 600 (or an Internet network server) for the TV terminal 610. The TV terminal 610 sends a request for application data to the Internet network server 600 of an application provider through the broadband interface 628 and receives non-linear A/V content such as content on demand. An Internet protocol processing module 634 provides functions used for the TV terminal 610 to process data received from the broadband system 600 (or the Internet network server). In particular, the Internet protocol processing module 634 delivers application data to the runtime environment processing 614 and delivers non-linear A/V data to the media player 636. The broadcast managing module 626 receives channel information of a selected program, for example, at least one of an event ID and a service ID of the selected program, through the broadband interface 628 as indicated by 616. The broadcast managing module 626 manages a mapping table indicating a mapping relationship between at least one of an event ID and a service ID and a corresponding frequency. That is, the broadcast managing module 626 receives information used to form the mapping table from the broadcast processing module 630 as indicated by 613 and generates and manages the mapping table based on the received information.

The broadcast managing module 626, upon receiving at least one of the event ID and the service ID from the broadband interface 628 as indicated by 616, searches for a corresponding frequency in the mapping table, detects a corresponding channel, and informs the broadcast interface module 620 or the broadband interface 628 of the frequency corresponding to the detected channel as indicated by 615 and 616. Thus, the TV terminal 610 may receive a corresponding broadcast program from the broadcast interface module 620 or the broadcast interface module 628.

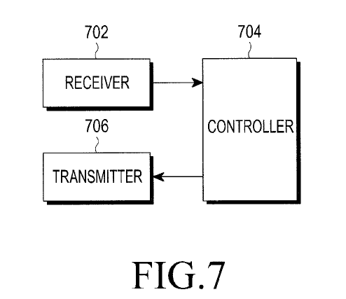

FIG. 7 is a block diagram of a portable terminal according to an embodiment of the present disclosure.

Referring to FIG. 7, the portable terminal may include a receiver 702, a transmitter 706, and a controller 704. The receiver 702 of the portable terminal receives information related to a broadcast service used to generate an EPG from an Internet network server through a broadband channel and delivers the information related to the broadcast service to the controller 704.

The information related to the broadcast service includes any information of broadcast contents that can be provided to a user, and more specifically, the information of broadcast contents may be configured and received in the form of an EIT, an SDT, and an NIT with respect to DVB metadata.

The controller 704 generates an EPG by using the information related to the broadcast service delivered from the receiver 702. Once channel information of a particular program, for example, at least one of an event ID and a service ID of the program, is input, the controller 704 delivers the channel information to the TV terminal through the transmitter 706. Herein, at least one of the event ID and the service ID indicates at least one of an event ID and a service ID of a program that is selected by a user. The portable terminal may also receive the EPG from the Internet network server instead of generating the EPG, and in this case, the portable terminal receives the EPG through the receiver 702 and delivers the received EPG to the controller 704.

Although components of the portable terminal are separated from each other in FIG. 7, the transmitter 706, the receiver 702, and the controller 704 may be implemented with one or more components.

It should be noted that a structural diagram and an operation diagram of a system and a structural diagram of an apparatus illustrated in FIGS. 1 to 7 are not intended to limit the scope of the present disclosure. That is, any entity, component, or operation shown in FIGS. 1 to 7 should not be construed as being an essential element for carrying out the present disclosure, and merely by including some elements, the present disclosure may be implemented by any suitable structure.

The above-described operations may be implemented by program code stored therein in a memory component of a TV terminal or a portable terminal. That is, a controller of the TV terminal or the portable terminal may execute the above-described operations by reading and executing the program code stored in the memory device by using a processor or a Central Processing Unit (CPU).

Various components and modules of the TV terminal or the portable terminal described in the present disclosure may operate by using a hardware circuit, for example, a Complementary Metal Oxide Semiconductor (CMOS) logic circuit, firmware, software and/or a combination of hardware and firmware and/or software inserted into a machine-readable medium. For example, various electric structures and methods may be carried out by using electric circuits such as transistors, logic gates, and on-demand semiconductors.

According to the present disclosure, information related to a broadcast service received in a wireless terminal through an Internet network may be efficiently transmitted to a TV, allowing a user to easily watch various channels. Moreover, the present disclosure prevents channel quality degradation that may occur according to a type or a state of a user-desired program in an existing hybrid broadcasting TV system.

Other effects that may be obtained or expected from the embodiment of the present disclosure are explicitly or implicitly disclosed in the detailed description of the embodiment of the present disclosure. That is, various effects expected from the embodiment of the present disclosure have been disclosed in the detailed description of the present disclosure.

While the present disclosure has been shown and described with reference to various embodiments thereof, it will be understood by those skilled in the art that various changes in form and detail may be made therein without departing from the spirit and scope of the present disclosure as defined by the appended claims and their equivalents.

What is claimed is:

1. A method for providing a broadcasting service at a first terminal, the method comprising:
receiving channel information of a program selected by a user from a second terminal;
detecting a frequency of the selected program from a mapping table that maps the channel information to a corresponding frequency;
locking a tuner to the detected frequency; and
receiving a broadcasting service of the program from a broadcasting network server.

2. The method of claim 1, further comprising:
sending a request for the broadcasting service of the selected program to an Internet network server if reception of the broadcasting service of the selected program from the broadcasting network server is not possible; and
receiving the broadcasting service of the program from the Internet network server in response to the request.

3. The method of claim 1, wherein the channel information comprises at least one of an event IDentifier (ID) indicating a program name and a service ID indicating a channel name or a service provider name.

4. The method of claim 1, wherein the mapping table is generated in advance based on information periodically received from the broadcasting network server.

5. A method for providing a broadcasting service at a first terminal, the method comprising:
receiving information related to a broadcasting service from an Internet network server;
generating an Electronic Program Guide (EPG) using the received information; and
transmitting channel information of a program selected by a user based on the EPG to a second terminal to provide the broadcasting service if the channel information is input.

6. The method of claim 5, wherein the information related to the broadcasting service comprises information of a broadcasting content that can be provided to the user, and the information of the broadcast content is configured in the form of an Event Information Table (EIT), a Service Description Table (SDT), or a Network Information Table (NIT).

7. The method of claim 5, wherein the channel information comprises at least one of an event IDentifier (ID) indicating a program name and a service ID indicating a channel name or a service provider name.

8. The method of claim 5, further comprising receiving the EPG from the Internet network server.

9. The method of claim 6, wherein the EIT comprises at least one of an event IDentifier (ID) indicating a program name, a program start time, and a program duration.

10. The method of claim 6, wherein the SDT comprises a service identifier (ID) indicating a channel name or a service provider name.

11. The method of claim 6, wherein the NIT comprises any network information transmitted over a current network, and the network information comprises at least one of a physical parameter of a transport stream, a cell list, a Digital Video Broadcasting (DVB) network name, a use frequency band, and whether to apply time slicing and Forward Error Correction (FEC).

12. A terminal for providing a broadcasting service, the terminal comprising:
a broadband interface configured to receive channel information of a program selected by a user;
a broadcast managing module configured to detect a frequency of the selected program from a mapping table that maps the channel information to a corresponding frequency and lock a tuner of the terminal to the detected frequency; and
a broadcast interface module configured to receive a broadcasting service of the program from a broadcasting network server.

13. The terminal of claim 12, wherein the broadband interface module sends a request for the broadcasting service of the program to an Internet network server if reception of the broadcasting service of the program from the broadcasting network server is not possible, and receives the broadcasting service of the selected program from the network server in response to the request.

14. The terminal of claim 12, wherein the channel information comprises at least one of an event IDentifier (ID) indicating a program name and a service ID indicating a channel name or a service provider name.

15. The terminal of claim 12, further comprising a broadcast processing module configured to generate the mapping table based on information periodically received from the broadcasting network server.

16. A terminal for providing a broadcasting service, the terminal comprising:
a receiver configured to receive information related to the broadcasting service from an Internet network server;
a controller configured to generate an Electronic Program Guide (EPG) using the received information; and
a transmitter configured to transmit channel information of a program selected by a user based on the EPG to provide the broadcasting service if the channel information is input.

17. The terminal of claim 16, wherein the information related to the broadcasting service comprises information of a broadcasting content that can be provided to the user, and the information of the broadcasting content is configured in the form of an Event Information Table (EIT), a Service Description Table (SDT), or a Network Information Table (NIT).

18. The terminal of claim 16, wherein the channel information comprises at least one of an event IDentifier (ID) indicating a program name and a service ID indicating a channel name or a service provider name.

19. The terminal of claim 16, wherein the EPG is received from the Internet network server.

20. The terminal of claim 17, wherein the EIT comprises at least one of an event identifier (ID) indicating a program name, a program start time, and a program duration.
